(19) United States
(12) Patent Application Publication
(10) Pub. No.: US 2012/0202460 A1
(43) Pub. Date: Aug. 9, 2012

(54) Invoking Denial of Service in Universal Mobile Telecommunications System (UMTS) Networks

(75) Inventors: Felix GESS, Hod Hasharon (IL); Ilya DEGTYAR, Hertzlia (IL); Sharon LEVY, Hadera (IL); Benny ARVIV, Zur Moshe (IL)

(73) Assignee: Broadcom Corporation, Irvine, CA (US)

(21) Appl. No.: 13/364,432

(22) Filed: Feb. 2, 2012

(30) Foreign Application Priority Data
Feb. 3, 2011 (IL) 211069

(51) Int. Cl. H04W 12/00

(52) U.S. Cl. 455/410

(57) ABSTRACT

A method of invoking denial of service in 3G networks is provided. The method includes receiving a downlink UMTS signal that is operating at a downlink UMTs frequency provided by the UMTS base station. A reference downlink UMTS signal is provided with a reference downlink UMTS frequency. The reference downlink UMTs frequency is aligned with the downlink UMTS frequency based on a frequency offset between the downlink UMTS frequency and the reference downlink UMTS frequency to provide an aligned frequency. A common pilot channel (CPICH) is transmitted over the reference downlink UMTS signal operating at the aligned frequency. Service for the UMTS base station is denied when the CPICH is combined with a UMTS base station CPICH operating at the downlink frequency.

### CROSS-REFERENCE TO RELATED APPLICATIONS

The present application is a U.S. Nonprovisional Application which claims the benefit of Israel Application No. 211069, filed on Feb. 3, 2011, which is incorporated herein by reference in its entirety.

### BACKGROUND

1. Field of Disclosure

The present invention relates to the field of 3G networks, and more particularly, to invoking denial of service in such networks.

2. Related Art

Denial of service in mobile communication networks focus on denying service within a specific geographic area for a specified group of base stations, thus affecting the cellular communication device connected to these base stations. There may be a wide variety of uses for denial of service in cellular communication networks: law enforcement usage, such as homeland security, prison, and bomb protection; preventing phone calls in desired spots. The denial of service may also be used where silence expected, such as museums, theaters and lectures. The denial of service may also be used where medical instruments may be damaged. The denial of service may further be used where isolation/privacy must be kept, such as prisons and restricted areas.

Existing techniques for denial of service in cellular communication networks uses transmission of white noise. However, universal mobile telecommunication system (UMTS) networks exhibit inherent to code division multiple access (CDMA) processing gain immunity, so transmission of white noise is either ineffective or requires high power transmission for longer periods of time.

### BRIEF DESCRIPTION OF THE DRAWINGS/FIGURES

Embodiments of the present disclosure are described with reference to the accompanying drawings. In the drawings, like reference numbers indicate identical or functionally similar elements. Additionally, the left most digit(s) of a reference number identifies the drawing in which the reference number first appears.

FIG. 1 is a high level schematic block diagram of the environment of the system according to some embodiments of the invention;

FIG. 2 is a high level schematic block diagram illustration of a system according to some embodiments of the invention;

FIG. 3 is a high level flowchart illustrating a method according to some embodiments of the invention;

FIG. 4 is a signal diagram illustrating an aspect according to some embodiments of the invention; and

FIG. 5 is a signal diagram illustrating another aspect according to some embodiments of the invention.

The present disclosure will now be described with reference to the accompanying drawings. In the drawings, like reference numbers generally indicate identical, functionally similar, and/or structurally similar elements. The drawing in which an element first appears is indicated by the leftmost digit(s) in the reference number.

### DETAILED DESCRIPTION OF THE INVENTION

One aspect of the invention provides a method for denying service from a universal mobile telecommunications system (UMTS) base station. The method includes receiving a downlink UMTS signal that may be operating at a downlink UMTS frequency provided by the UMTS station. A reference downlink UMTS signal may be provided with a reference downlink UMTS frequency. The reference downlink UMTS frequency may be aligned with the downlink UMTS frequency and the reference downlink UMTS frequency to provide an aligned frequency. A common pilot channel (CPICH) may be transmitted over the reference downlink UMTS signal operating at the aligned frequency. Service for the UMTS base station may be denied when the CPICH is combined with a UMTS base station CPICH that is operating, at the downlink UMTS frequency.

Prior to setting forth the detailed description, it may be helpful to set forth definitions of certain terms that will be used hereinafter.

The term “Universal Mobile Telecommunication System” commonly abbreviated to “UMTS” as used herein in this application refers to the third-generation (3G) mobile telecommunications technologies, which is also being developed into a 4G technology. The most common form of UMTS uses W-CDMA (IMT Direct Spread) as the underlying air interface but the system also covers TD-CDMA and TD-SCDMA.

The term “rake receiver” as used herein in this application refers to a radio receiver designed to counter the effects of multipath fading. It does this by using several “sub-receivers” called fingers, that is, several correlators each assigned to a different multipath component. Each finger independently decodes a single multipath component; at a later stage the contribution of all fingers are combined in order to make the most use of the different transmission characteristics of each transmission path. This could very well result in higher signal-to-noise ratio (or Eb/NO) in a multipath environment than in a “clean” environment.

The term “Common Pilot Channel” or CPICH as used herein in this application refers to a down link pilot transmitted by the base station. Once the radio link is established, the CPICH may be used by all UEs for channel estimation, for data and control decoding, measurements and other radio link maintenance purposes.

The following Detailed Description refers to accompanying drawings to illustrate exemplary embodiments consistent with the present disclosure. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to effect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the present disclosure. Therefore, the Detailed Description is not meant to limit the present disclosure. Rather, the scope of the present disclosure is defined only in accordance with the following claims and their equivalents.

Embodiments of the present disclosure may be implemented in hardware, firmware, software, or any combination thereof. Embodiments of the present disclosure may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

The following Detailed Description of the exemplary embodiments will so fully reveal the general nature of the present disclosure that others can, by applying knowledge of those skilled in relevant art(s), readily modify and/or adapt for various applications such exemplary embodiments, without undue experimentation, without departing from the spirit and scope of the present disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

### An Exemplary UMTS Network

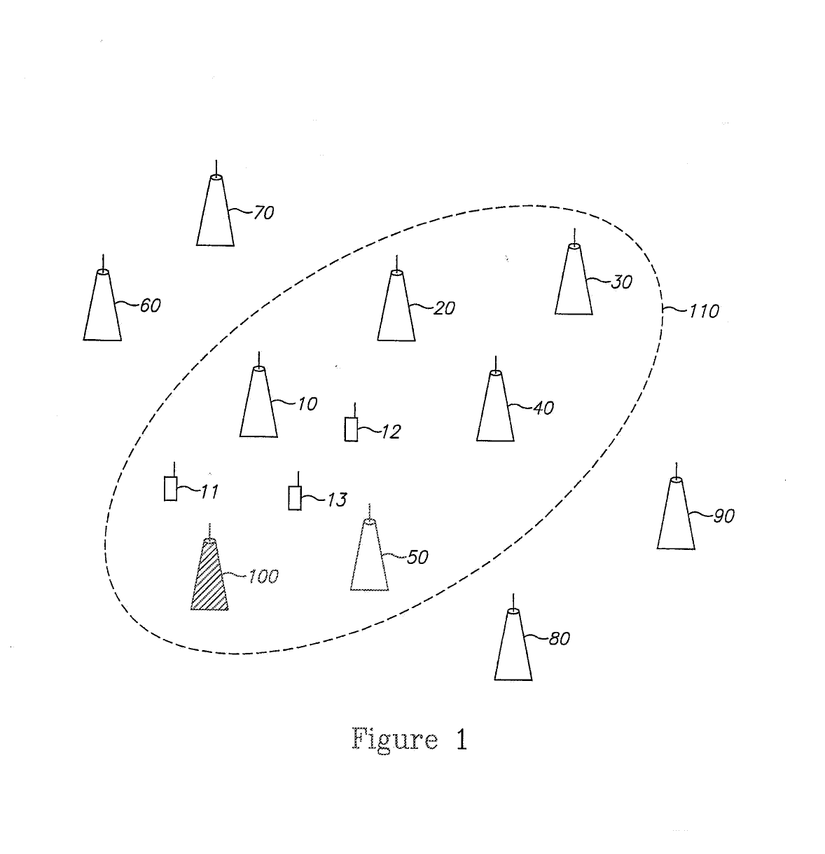

FIG. 1 is a high level schematic block diagram of the environment of the system according to some embodiments of the invention. A system 100 that invokes denial of service in a UMTS network may be deployed within a cellular communication network that includes base stations 10 through 90 and handsets 11 through 13. Handsets 11 through 13 may include cellular communication devices also referred to as user equipment (UE). For the sake of simplicity only three handsets are shown. As shown below, system 100 may invoke a denial of service within a specified area 110 of the cellular network thus affecting a specified number of base stations (aka victim base stations).

Invoking a denial of service starts with a UMTS environment scan. System 100 may be configured to detect possible serving base stations that a UE may use, and extract base stations parameters. In particular, these parameters include: used scramble code, frequency, and time offset relative to an independently generated signal. Then, selection of a subset of base stations to be denied of service needs to be done. Then, based on the extracted parameters, and specifically those relating to timing, a “fake” downlink-like signal is generated and transmitted by system 100. This downlink signal is synchronized with the down link signal of the selected (victim) bases stations.

According to embodiments of the invention, system 100 is configured to invoke denial of service by disturbing an ongoing call until a call drop occurs and/or by preventing new call setup completion. By generating the modified CPICH signal, UE receivers are forced to add it as a reference signal, by virtue of their rake receivers, and therefore it causes large degradation in the downlink channel and optionally in the uplink channel because the uplink time and frequency align the downlink signal received by the UE.

### An Exemplary System

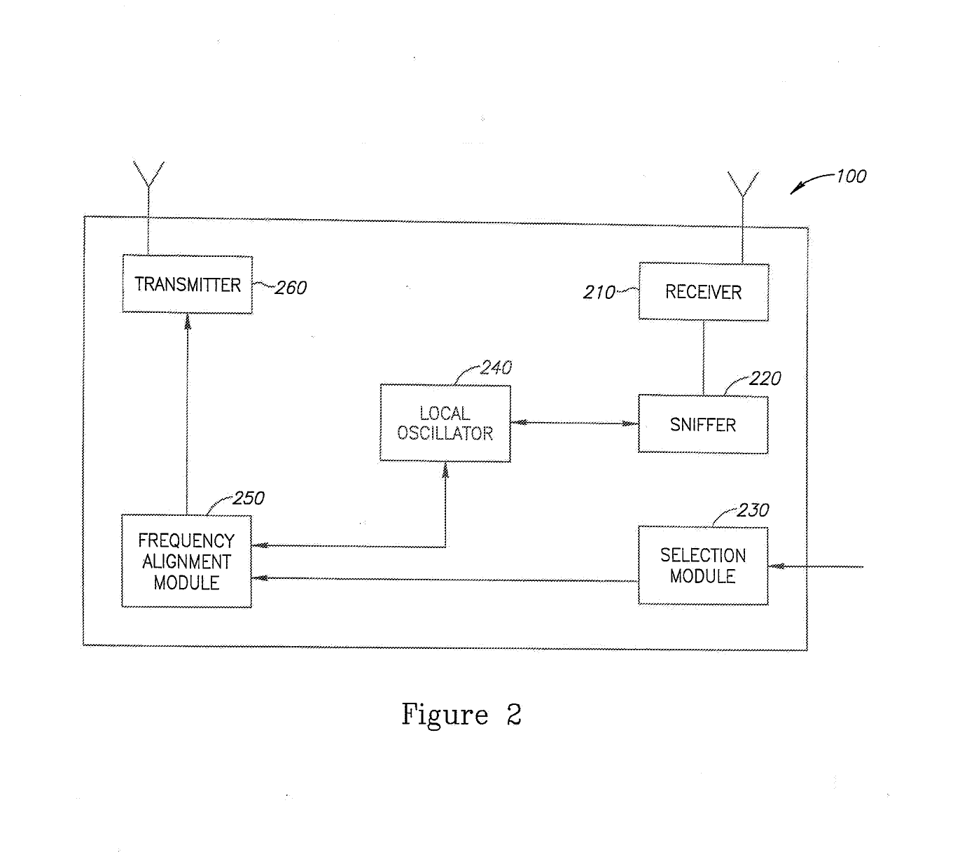

FIG. 2 is a high level schematic block diagram illustrating system 100 in more details, according to some embodiments of the invention. System 100 may include a receiver 210 coupled to a sniffer 220 which in turn is connected to a local oscillator 240 which is connected to a frequency alignment module 250 and further to a transmitter 260, System 100 further includes a selection module 230 that may receive instructions from outside of system 100.

In operation, sniffer 220 may be configured to analyze a set of downlink UMTS signals received by receiver 210 to: (i) determine a set of active UMTS base stations associated with the downlink signals and (ii) extract for each UMTS base station, a frequency offset between the downlink signal and a frequency of local oscillator 240 and parameters selected from a group comprising at least one of: scramble code, neighbors list, reception power, and timing information. Selection module 230 may be configured to select at least one victim UMTS base station for which a denial of service is required, based on any of the following: priority knowledge, cell power transmission, and neighbors list.

Frequency alignment module 250 may be configured to align at least one of: frequency and sample time of the independently generated downlink signal, based on the frequency offset associated with the at least one selected victim UMTS base station. Transmitter 260 may be configured to transmit a Common Pilot Channel (CPICH) over the independently generated UMTS downlink signal associated with local oscillator 240, wherein the CPICH parameters are based on at least one of the aligned frequency and the aligned sample time. Further, sniffer 220 and the frequency alignment module 250 may be configured to periodically repeat their operation, so that the active UMTS base stations and their corresponding frequency offset are monitored such that the CPICH parameters are updated over time.

Consistent with some embodiments of the invention, the denial of service may be achieved by a plurality of alternative variation on the timing, frequency, relative location of system 100, location of the victim base stations 10 through 50, and the like.

Denial of service for a specified victim base station may be achieved by transmitting a valid CPICH associated with time and frequency relation with the victim base CPICH. For example, it could have the same frequency as the victim base station CPICH. It could have constant frequency offset relative to the victim base station, it could be multiplied by the linear combination of several frequencies offset relative to the victim base station.

Similarly, the timing of system 100 may be the same time as victim base station, prior to the victim base station or alternatively exhibiting a plurality of time replicas of the CPICH.

Consistent with one embodiment of the invention, system 100 may use a standard CPICH or a CPICH with frequency offset (the latter option will enlarge the potential damage to the UE receiver). When using the standard CPICH, combining of that “fake finger” will add noise to the combiner of UE rake receiver and actually reduce the WCDMA processing gain. When using CPICH with frequency offset, in addition to the previously described effect, the UE may modify its frequency beyond the UE/base-state capabilities and degrade the inner loop power control for both the uplink (the NB decoding of the uplink TPC request) and by increasing the downlink TPC error rate, it may cause UE to stop transmission. It should be noted that the use of Rake receiver by the UE is not mandatory and it is only used herein to illustrate some embodiments of the present invention.

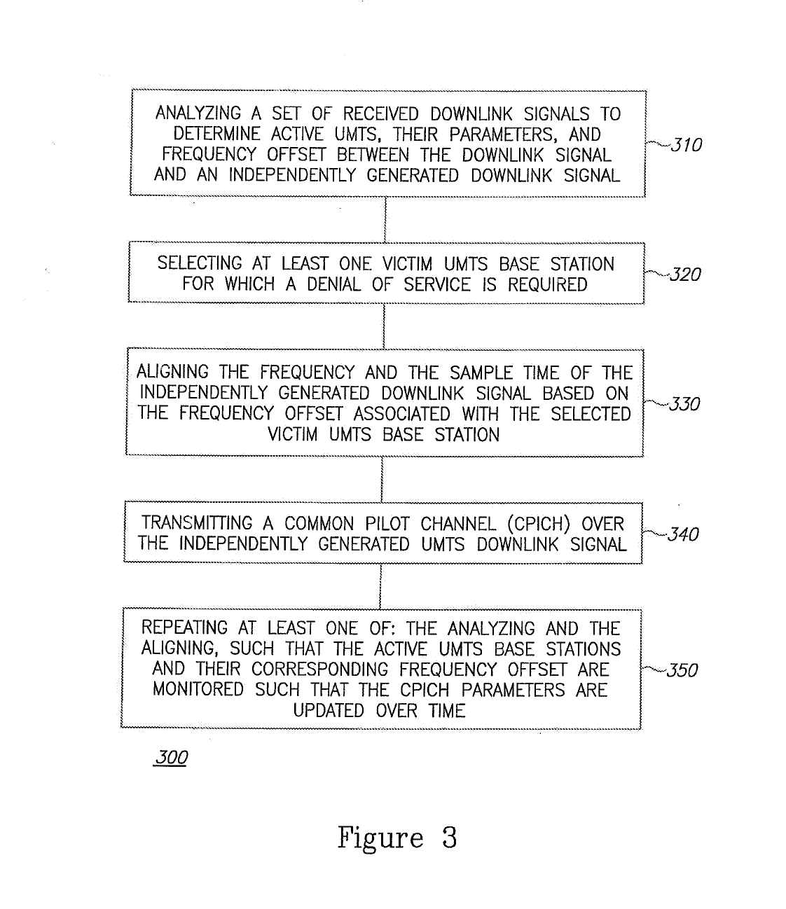

FIG. 3 is a high level flowchart illustrating a method 300 according to some embodiments of the invention. The method 300 starts with step 310 in sniffing the “UMT neighborhood” to derive parameters used in the downlink channels. For example, the aim of the sniffing presented in stage 310 is to find all available base stations that system 100 may be able to receive. The input is the down link frequencies set. The output of step 310 is a list of the available base stations and their parameters relevant to the service denial: scramble code, neighbor list, reception power, timing information and frequency offset between the jammer and the base station.

Following the completion of step 310, the method 300 proceeds to step 320 in selecting the victim base stations. For example, in selecting the victim base stations, system 100 selects the set of base stations which it may imitate. The selection is based on the following criteria: priory knowledge; cell power transmission; and neighbors list. It may occur that the system 100 does not have the required parameters of the selection base station, for example if a cell was selected from a neighbor list but was not analyzed in the sniffing stage. Then additional sniffing process may be done for the desired base station.

Following the completion of step 320, the method 300 proceeds to step 330. In step 330, frequency and sample time of the victim base stations are aligned with the independently generated downlink signal. For example, frequency alignment of system 100 may have a frequency offset relative to the victim base station. The frequency offset could be estimated based on the received signal of the selected base station. Based on the estimated frequency offset, system 100 may align its frequency and sample time. One option is to align the local oscillator 240 to the frequency of the selected base station.

Following the completion of step 330, the method 300 proceeds to step 340 in transmitting a CPICH over the independently generated downlink signal. In step 340, system 100 is generating a valid CPICH like signal. The UE is receiving a CPICH signal, and makes it part of the combining process by assigning a RAKE finger on it. Since there is no data channel along the CPICH, the combining of the received signal for system 100 adds only noise to the combining process. The damage to the UE is severe since the signal for system 100 signal is de-spread coherently, as true WDCMA data, and the interfering noise gains the spreading gain, which is the benefit of the direct sequence spread spectrum method.

When system 100 uses CPICH with frequency offset, the UE will estimate and correct frequency offset which exceeds the base station/UE connection capabilities. This could degrade the uplink and downlink inner loop power control. The timing of the transmitted CPICH signal is relative to the expected UE time, The CPICH like signal may be one of the following with a frequency offset as defined in the CPICH Standard, such as provided by 3^{RD} GENERATION PARTNERSHIP PROJECT: Feasibility Study on the Mitigation of the Effect of the Common Pilot Channel (CPICH) Interference at the User Equipment, version 5.1.0, (2002-2012), which is incorporated herein by reference in its entirety.

Alternatively, a generation of composite CPICH with frequency offset signal is also possible, The formal expression of the composite CPICH is given below:

$$Composite\_CPICH ( t ) = A ( t ) \cdot {\sum }_{k = 0}^{K - 1} {a}_{k} \cdot {e}^{j 2 π {T}_{s} {f}_{k} t}$$

Where A(t) is the standard CPICH signal, K is the number of the rotators, aₖ is the gain of each one and fₖ is its frequency and Tₛ is the symbol rate.

Step 310 and step 330 may be periodically repeated in step 350 so that any drift in frequency as well as any change in the “UMTS neighborhood” will be monitored and the transmitted CPICH updated accordingly.

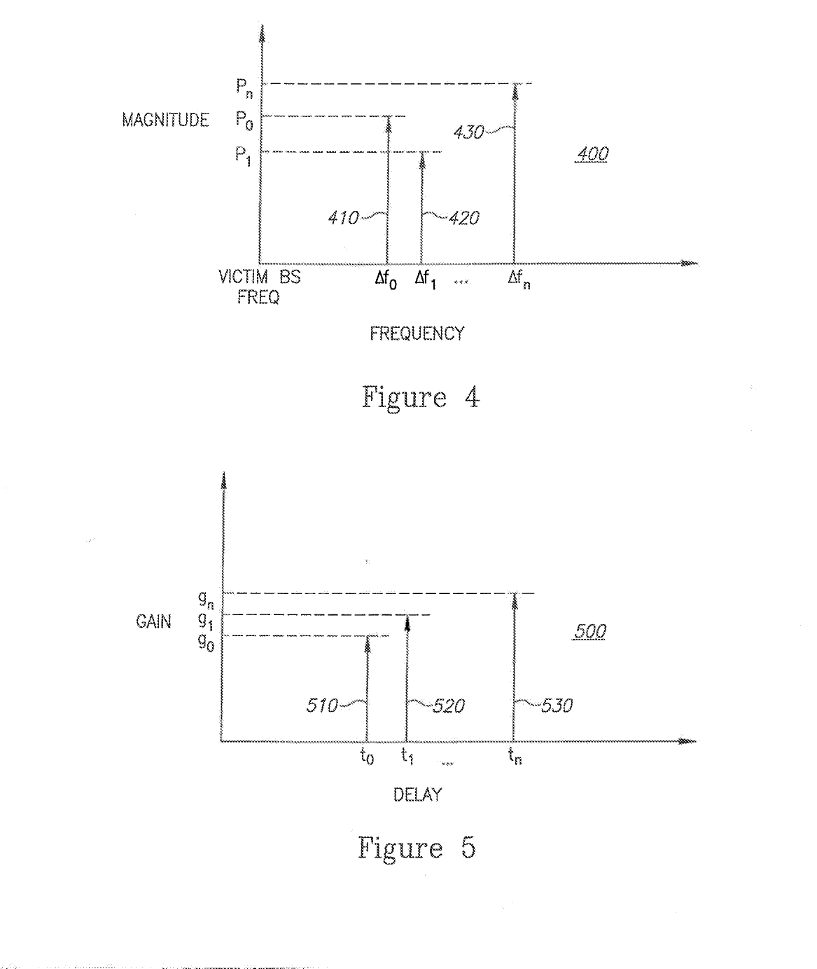

FIG. 4 is a signal diagram illustrating an aspect according to some embodiments of the invention; A CPICH with frequency offset is described in 400. Actually, this is a sum of several CPICH signals, each having a magnitude and frequency offset, which may be different for each replica.

Consistent with one embodiment of the invention, since the frequency offset correction is not ideal, there is a drift between the macro cell frequency and the system 100 clock frequency. A periodic frequency offset correction must be applied. The frequency correction is done by: entering system 100 into sniffing mode; “listening” to the selected base station; estimation of the frequency offset; modifying the frequency generation mechanism of the jammer according to the estimated frequency offset.

Advantageously, the UMTS signal and spreading process are exploited to improve system 100 efficiency by eliminating the CDMA inherent noise immunity and further by using CPICH with frequency offset to break the inner loop power control.

FIG. 5 is a signal diagram illustration another aspect according to some embodiments of the invention. Graph 500 shows transmit multi-path signal. This is the same CPICH signal that is transmitted in several delays, each replica delay and gain may be different, 510 through 530.

Consistent with one embodiment of the invention a further improvement for the denial of service may be achieved by generating of Primary SCH and Secondary SCH at frequency offset similar to the CPICH frequency offset. This may prevent UEs with PSC/SSCH based frequency estimation to eliminate the interferer false CPICH signal.

Consistent with one embodiment of the invention a further improvement for the denial of service may be achieved by adding constant transmission of PSCH and unused SSCH with offsetted frequency offset. This way the UE will have hard time to find new serving base stations in addition to the current victim base stations.

Advantageously, embodiments of the invention eliminate the well known CDMA processing gain and are therefore more energy efficient. Further, the power control loop in UMTS usually increases the system stability. As shown above, embodiment of the invention effect the power control signaling quality and therefore reduces the power control stability gain.

### CONCLUSION

It is to be appreciated that the Detailed Description section, and not the Abstract section, is intended to be used to interpret the claims. The Abstract section may set forth one or more, but not all exemplary embodiments, of the present disclosure, and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

it will be apparent to those skilled in the relevant art(s) that various changes in form and detail can be made therein without departing from the spirit and scope of the present disclosure. Thus the present disclosure should not be limited by any of the above-described exemplary embodiments, but should be defined only in accordance with the following claims and their equivalents.

What is claimed is:

1. A system, comprising:
a downlink receiver configured to receive a downlink universal mobile telecommunications system (UMTS) signal that is operating at a downlink UMTS frequency provided by an UMTS base station, the UMTS base station being characterized as having a first common pilot channel (CPICH);
a local oscillator configured to provide a reference downlink UMTS signal with a reference downlink UMTS frequency;
a frequency alignment module configured to align the reference downlink UMTS frequency with the downlink UMTS frequency based on a frequency offset between the downlink UMTS frequency and the reference downlink UMTS frequency to provide an aligned frequency; and
a downlink transmitter configured to transmit a second CPICH over the reference downlink UMTS signal operating at the aligned frequency, the second CPICH being configurable to cause a service to be denied to the UMTS base station, the downlink transmitter being configurable to cause a denial of service to the UMTS base station by transmitting the second CPICH at a substantially proportional frequency as the first CPICH.

2. The system of claim 1, further comprising:
a selection module configured to select the UMTS base station when a denial of service for the UMTS base station is required; and
a sniffer configured to extract for the UMTS base station the frequency offset between the downlink UMTS frequency and the reference downlink UMTS frequency.

3. The system of claim 2, wherein the sniffer is further configured to:
determine the UMTS base station that provided the downlink UMTS signal; and
extract a parameter from the UMTS base station.

4. The system of claim 3, wherein the parameter extracted from the UMTS base station includes a scramble code, a neighbors list, a reception power, or timing information for the UMTS base station.

5. The system according to claim 2, wherein the sniffer is further configured to periodically update the frequency offset so that the CPICH is updated.

6. The system of claim 2, wherein the selection module is further configured to determine when the denial of service for the UTMS base station is required based on priority knowledge, cell power transmission, or a neighbors list.

7. The system of claim 1, wherein the frequency alignment module is further configured to align a reference downlink UMTS sample time for the reference downlink UMTS signal with a downlink UMTS sample time for the downlink UMTS signal based on the frequency offset.

8. The system of claim 7, wherein the frequency alignment module is further configured to:
provide the aligned frequency based on the aligning of the reference downlink UMTS frequency with the downlink UMTS frequency; and
provide an aligned sample time based on the aligning of the reference downlink UMTS sample time with the downlink UMTS sample time.

9. The system according to claim 7, wherein the frequency alignment module is further configured to periodically align the reference downlink UMTS frequency with the downlink UMTS frequency so that the CPICH is updated.

10. The system of claim 8, wherein the downlink transmitter is further configured to transmit the CPICH over the reference downlink UMTS signal based on the aligned frequency and the aligned sample time.

11. A method for denying service from an universal mobile telecommunications system (UMTS) base station, comprising:
receiving a downlink UMTS signal that is operating at a downlink UMTS frequency provided by the UMTS base station, the UMTS base station being characterized as having a first common pilot channel (CPICH);
providing a reference downlink UMTS signal with a reference downlink UMTS frequency;
aligning the reference downlink UMTS frequency with the downlink UMTS frequency based on a frequency offset between the downlink UMTS frequency and the reference downlink UMTS frequency to provide an aligned frequency;
transmitting a second CPICH over the reference downlink UMTS signal operating at a substantially proportional frequency as the first CPICH; and
denying service to the UMTS base station based on the second CPICH.

12. The method of claim 11, further comprising:
selecting the UMTS base station when a denial of service for the UMTS base station is required; and
extracting for the UMTS base station the frequency offset between the downlink UMTS frequency and the reference frequency.

13. The method of claim 12, wherein the extracting further comprises:
determining the UMTS base station that provided the downlink UMTS signal; and
extracting a parameter from the UMTS base station.

14. The method of claim 13, wherein the parameter extracted from the UMTS base station includes a scramble code, a neighbors list, a reception power, or timing information for the UMTS base station.

15. The method of claim 12, wherein the extracting further comprises:
updating periodically the frequency offset so that the CPICH is updated.

16. The method of claim 12, wherein the selecting further comprises:
determining when the denial of service for the UTMS base station is required based on priority knowledge, cell power transmission, or a neighbors list.

17. The method of claim 11, wherein the aligning further comprises:
aligning a reference downlink UMTS sample time for the reference downlink UMTS signal with a downlink UMTS sample time for the downlink UMTS signal based on the frequency offset.

18. The method of claim 17, wherein the aligning further comprises:
providing the aligned frequency based on the aligning of the reference downlink UMTS frequency with the downlink UMTS frequency; and
providing an aligned sample time based on the aligning of the reference downlink UMTS sample time with the downlink UMTS sample time.

19. The method of claim 17, wherein the extracting further comprises:
aligning periodically the reference downlink UMTS frequency with the downlink UMTS frequency so that the CPICH is updated.

20. The method of claim 19, wherein the transmitting further comprises:
transmitting the CPICH over the reference downlink UMTS signal based on the aligned frequency and the aligned sample time.
